(19) United States
(12) Patent Application Publication
(10) Pub. No.: US 2016/0132327 A1
(43) Pub. Date: May 12, 2016

(54) VISUAL TOOL FOR REVERSE ENGINEERING SOFTWARE COMPONENTS

(71) Applicant: General Motors LLC, Detroit, MI (US)

(72) Inventors: Saeid Tehrani, Farmington Hills, MI (US); Aditya Aggarwal, Windsor, Ontario (CA); Michael L. Dessert, Farmington Hills, MI (US)

(21) Appl. No.: 14/534,877

(22) Filed: Nov. 6, 2014

(51) Int. Cl. G06F 9/44

(52) U.S. Cl. CPC G06F 8/74; G06F 8/20

(57) ABSTRACT

A system and method of displaying a software application using a software architecture tool that includes: receiving a portion of an existing software application at the software architecture tool; identifying one or more software components of the existing software application from the received portion; automatically identifying a tier and layer location for each standard software component; and presenting one or more images that each represent the standard software component to a user, wherein the images visually identify a tier and layer location of each standard software component.

### TECHNICAL FIELD

The present invention relates to the architecture of software applications and, more particularly, to reverse engineering of existing software applications such that their components can be visually displayed according to their appropriate layers while any conflicts and non-standard components can be identified, reported and/or corrected.

### BACKGROUND

Software applications control the operation or function of a wide variety of mechanical and electrical devices. As the functions of these systems/devices have become increasingly complex, the design or architecture of the software applications have also become more complex as well. Software applications often include an interrelated structure of different software components that work in harmony. However, as software applications include increasing numbers of software components, the chance increases that some of these software components are incompatible with each other. Also, it is possible that one software component that has been added to the software application may require the presence of another software component to properly function. When software architects create software applications that have multiple layers and many software components in each layer it can be challenging to identify the needs of each software component, such as dependencies or incompatibilities of other components. Further, software architects often want to integrate new software components with existing software applications. It can be helpful to identify the components, interdependencies of components, and locations of components from existing software applications and integrate those components with new software components.

### SUMMARY

According to an embodiment, there is provided a method of displaying a software application using a software architecture tool. The steps include receiving a portion of an existing software application at the software architecture tool; identifying one or more software components of the existing software application from the received portion; automatically identifying a tier and layer location for each standard software component; and presenting one or more images that each represent the standard software component to a user, wherein the images visually identify a tier and layer location of each standard software component.

According to another embodiment, there is provided a method of generating a software application using a software architecture tool. The steps include receiving a portion of an existing software application at a software architecture tool; identifying one or more software components of the existing software application from the received portion; determining whether software components are standard or non-standard; automatically identifying a tier and layer location for each standard software component; receiving one or more software selections from a user for non-standard components or when a software component belongs to a plurality of layers; and presenting one or more images to a user that each represent an identified software component, wherein the presented images identify a location within a tier and a layer.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a computer system that is capable of utilizing the method disclosed herein;

FIG. 2 is a flow chart depicting an embodiment of a method of displaying a software application structure using a software architecture tool;

FIG. 3 is a flow chart depicting another embodiment of a method of displaying a software application structure using a software architecture tool;

FIG. 4 is a flow diagram of the inputs and outputs of a software architecture tool; and

FIG. 5 is a screen shot depicting an embodiment of a graphical user interface (GUI) of the software application.

### DETAILED DESCRIPTION OF THE ILLUSTRATED EMBODIMENTS

The system and method described below implements a software architecture tool that can receive inputs in the form of a physical packaging of existing software components, a deployment descriptor, and/or an IT bill of material (IT BOM) from an existing or previously designed software application and use one or more of these inputs to produce a visual and/or actual representation of the existing software application. The software architecture tool can receive input from existing software applications having multiple software components organized in a plurality of layers and tiers and appropriately display each software component in a particular layer within a tier. Additional software components can be selected by a software architect or user, placed in an appropriate tier and layer of the existing software application, and cross-referenced with one or more repositories, such as an IT standards catalog, an enterprise component specification knowledge base, an enterprise component binary repository, or an enterprise component template repository. The software architecture tool can receive input from any one or more of the repositories, determine any co-dependencies or conflicts that exist between selected software components, existing software components, or both using information found in the repositories, and automatically add software components to the existing software application based on the co-dependencies or conflicts.

For example, the software architecture tool can search the IT standards catalog to identify a software component as a standard component or a non-standard component. Standard software components can be components that are identifiable in the IT standards catalog. In contrast, if the existing or selected software component cannot be identified in the IT standards catalog, the software architecture tool can classify the component as non-standard and prompt the user to input the location in the binary repository and specification of the software component. The software architecture tool can also identify dependencies between software components of the existing software application and those selected by a user by accessing the enterprise component specification knowledge base. After each software component has been identified from the existing software application or selected by the user and any dependencies have been resolved using the enterprise component specification knowledge base, the software architecture tool can generate a new IT BOM containing a list of standard and non-standard materials. The new IT BOM can include not only the components of the existing software application but also any components added/replaced by the user. The software architecture tool can then place the existing and selected software components on appropriate layers, generate build descriptors using the enterprise component template repository, and generate a skeletal software application comprising both the components from the existing software application as well as any user-selected components using the enterprise component binary repository that identifies the software binary components for a new software application. The build descriptors can include physical java packaging of existing/sample code for creating the new software application. The software architecture tool can also identify incompatibilities between the software components from the existing software application and the software components selected by the user and output the incompatibilities as an incompatibility report using the enterprise component specification knowledge base.

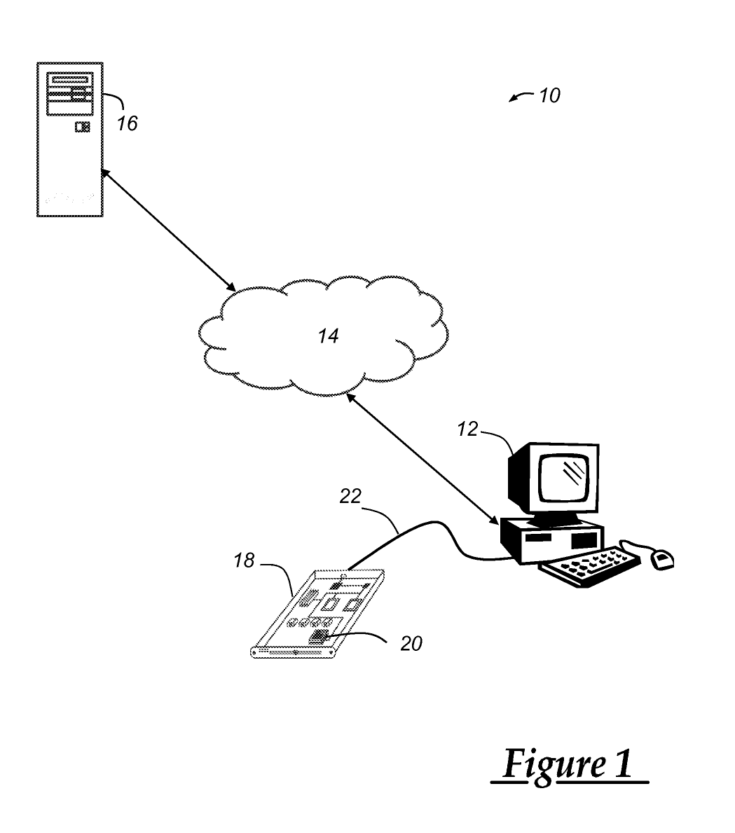

With reference to FIG. 1, there is shown a computing system 10 that can be used to implement the software architecture tool described below. The system 10 generally includes a personal computer (PC) 12 and, optionally, a land communications network 14 connected to a remotely-located computer 16. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such computing system 10; however, other systems not shown here could employ the disclosed method as well.

Personal computer (PC) 12 can be a computing device operated by a user or software architect that includes hardware in the form of one or more microprocessors, memory devices, peripherals, and modems. A typical PC 12 can receive input from peripherals such as a keyboard and a mouse and output information via other peripherals, such as a monitor. In this arrangement, it is common for the PC 12 to be remain stationary on a desktop or other similar location. However, it is also possible to implement the PC 12 as a portable device having many if not all of the elements discussed above, such as a laptop or handheld computer (not shown). The microprocessors of the PC 12 can include a central processing unit (CPU) that executes software or software instructions in form of computer-readable code. The software can be stored in the memory device, which can be any type of non-volatile memory as is known in the art. Communications between the CPU and other hardware elements can be carried out over a bus, as can be implemented using a printed circuit board (PCB). In one implementation, the PC 12 can use the CPU to access software that carries out the software architecture tool and is stored in the memory devices of the PC 12. A user of the software architecture tool can provide input and receive output using peripherals of the PC 12, such as the keyboard, the mouse, or the visual display. In addition to software implementing the software architecture tool, the memory devices can store one or more databases containing an IT standard catalog, an enterprise component specification knowledge base, an enterprise component binary repository, and enterprise component templates. When executing the software architecture tool, the CPU can access the memory devices in response to user input.

The PC 12 can be communicatively linked to a microcontroller 18 having a microprocessor 20. The PC 12 can then use its CPU to read computer-readable instructions to the memory portion of the microprocessor 20 in the form of a software application and also write updated computer-readable instructions to the memory portion of the microprocessor 20. The computer readable instructions can be communicated between the PC 12 and the microprocessor 20 of the microcontroller 18. In one implementation, the PC 12 is connected via a data cable 22 having connectors on each end, such as universal serial bus (USB) connectors, that bi-directionally carries data between the PC 12 and the microcontroller 18.

In some implementations, the databases may be located remote from the PC 12 at the remotely-located computer 16. In that case, the PC 12 can be linked with the computer 16 via the land network 14. The land network 14 may be a conventional land-based telecommunications network that is connected to one or more landline telephones. For example, land network 14 may include a public switched telephone network (PSTN) such as that used to provide hardwired telephony, packet-switched data communications, and the Internet infrastructure. One or more segments of land network 14 could be implemented through the use of a standard wired network, a fiber or other optical network, a cable network, power lines, other wireless networks such as wireless local area networks (WLANs), or networks providing broadband wireless access (BWA), or any combination thereof

The remotely-located computer 20 can be one of a number of computers accessible via a private or public network such as the Internet. The remotely-located computer 20 can act as a repository for the software architecture tool. Rather than maintaining the software and databases locally at the PC 12, it may access the remotely-located computer 20 to obtain this information.

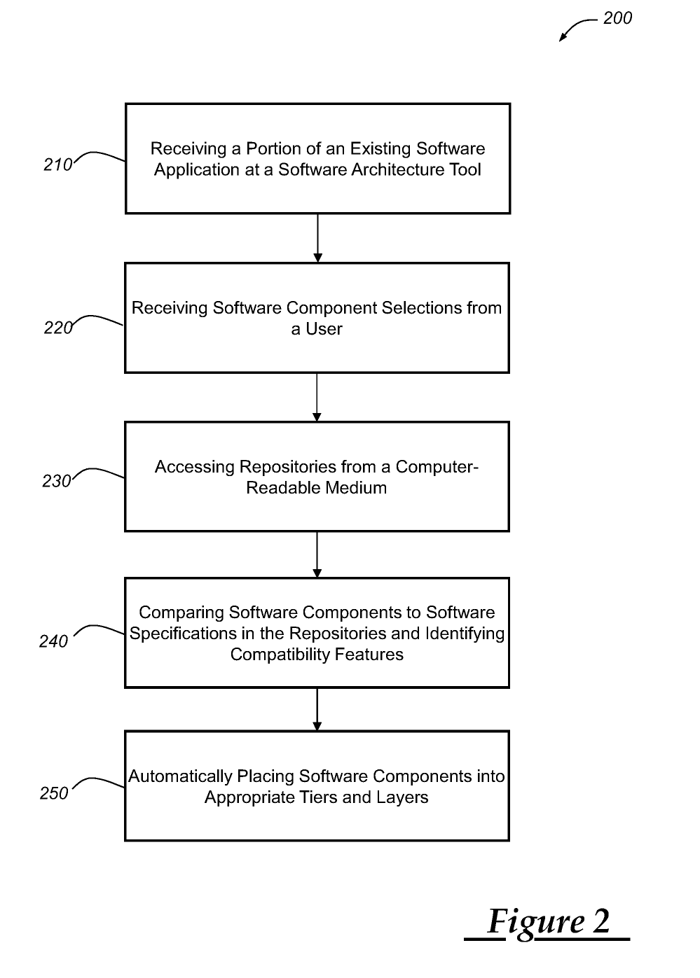

Turning now to FIG. 2, there is shown an embodiment of a method 200 of displaying and possibly generating a software application structure using a software architecture tool. The method 200 begins at step 210 by receiving a portion of an existing software application at the software architecture tool. This can include identifying software components from an existing software application and placing those components into a software tier and layer shown on a peripheral of the PC 12. Existing software applications often include software components that have identifiable properties and are assigned to a tier and layer as part of the structure of the existing software application. The existing software application can be stored on a microcontroller that operates using the existing application or on a memory device that the PC 12 can access. The CPU operating the software application can access the existing software application via a communication link to the PC 12 that implements the software architecture tool. The software architecture tool can access the existing software components, copy or receive the contents and the identifiable properties of the software components, and display the software components of the existing software application.

The software components or the identifiable properties of the components can be provided to the software architecture tool in the form of the physical software components of the existing software application, an IT bill of material (IT BOM), or a deployment descriptor or deployment package descriptor. The identifiable properties of the software components can include software identifiers, such as software identities and version numbers, that the software architecture tool can use to integrate the existing software application into a new software application. The software identifiers and software version numbers can be used to display the software components in appropriate tiers and layers of the new software application. Or the software identifiers can be used to compare software components from the existing software application with software components newly-selected by the user that together can be assembled into a new software application. For instance, the software identifiers can be used to identify existing software components that are open source software (OSS), which can later be used to identify dependencies between software components. The existing (presumably working) application may include software components that are non-standard. The non-standard components may be identified and replaced with standard software components. The replacement of non-standard software components with standard software components may later be verified to ensure that the software application functions without error. The method 200 proceeds to step 220.

At step 220, a plurality of software component selections are received from a user via a peripheral of the PC 12. Software architects or users of the PC 12 can model a new software application that incorporates at least a portion of an existing software application by selecting new software components that are visually displayed using a mouse or keyboard using the PC 12. The PC 12 can present the user a graphical user interface (GUI) that includes a plurality of software components on one side or section of the GUI. As part of selecting software components, a user can first select a software tier into which subsequent software component selections can be placed. Then, the user can identify one or more software components to be placed in the software tier. The software component(s) may also belong to more than one software layer. If so, the user may also be prompted to select which software layer(s) the software component belongs to.

The software components can be selected from visually-displayed images representing those components and combined into a visually-displayed software application that incorporates software components from both the existing software application and those selected by the user. The new software application can then be shown on an opposite side or section of the GUI from the software components. The new, visually-displayed software application depicts not only the components but also software tiers and software layers. One example of such a GUI can be implemented using available software, such as an IDE like Eclipse. A software tier can define a separate memory space such as the user's browser, an app server, or a database whereas the software layer can define a logical structure of software components within a tier. The software components can be described as a set of computer-readable instructions that carry out a particular function. The software components can include subroutines, data types, and other computer-readable instructions that communicate with other software components and direct hardware elements in accordance with a prescribed function. In one implementation, individual software components can each be depicted using an icon or other unique symbol that visually identifies the software component to the user. When architecting a software application, the user can select one or more software components with a mouse and drag the software component to a layer area on the GUI dedicated to assembling one or more new software components with existing software components into a new software application. There, the software components can be organized according to the tier and/or layer of the software application. The method 200 proceeds to step 230.

At step 230, one or more repositories are accessed from a computer-readable medium. The repositories include an IT standard catalog, an enterprise component specification knowledge base, an enterprise component binary repository, and an enterprise component template repository. Once the user has selected the software components to be included in a software layer or tier and those components are displayed along with existing software components by the PC 12, one or more of the repositories can be searched to identify the selected software components or relationships between the selected software components and existing software components.

The IT standard catalog can be a database identifying software components that are recognized by a particular company or organization and used to verify the identity of the selected software components. The software components in the IT standard catalog can include a software identifier for each software component and be classified according to the software identifier as enterprise standard, non-standard, a deviation, freeware, shareware, open source, or a commercial component that may or may not be associated with an enterprise licensing agreement (ELA). In addition, vehicle manufacturers often identify software components in an IT standard catalog as being acceptable for use in their vehicles. By ensuring that the electrical or electromechanical devices of a vehicle, such as a vehicle control module or other microcontroller, use a particular set of software components included in the IT standard catalog for particular devices, the vehicle manufacturer can better control the operation of their devices and vehicles. In one example, an existing software application can be designed for installation in a vehicle control module. And when software components are selected for inclusion in the existing software application, the IT standard catalog can identify any software components that may not be acceptable or approved for use with the vehicle or vehicle control module based on a software identifier.

The software components found in the IT standard catalog can be labeled “standard” because the components are known and approved for use in a vehicle or other particular application. However, there may also be times when software components not found in the IT standard catalog may be included in the new software application. In this case, the software component can be identified as a “non-standard” component and the user may be prompted to identify the name of the software component or the location (e.g., a URL) where the non-standard component can be found. Non-standard components can include freeware, shareware, or open source software not recognized by the IT standard catalog which may be approved for use before the new software application were used in vehicle production. Ultimately, the software architecture tool allows the user to add software components to, remove software components from, or update software components included with the existing software application. The method 200 proceeds to step 240.

At step 240, the software components are compared to the software specifications in the repositories and compatibility features are identified between the selected software components and the software specifications stored in the repositories. The compatibility features of the selected components are then displayed via a peripheral of the PC 12. Compatibility features include determining when two or more selected software components are not operable when combined or when other more appropriate software components can be selected. When this occurs, the PC 12 can display the incompatible or more appropriate software components in a common color, such as red. The PC 12 could also automatically delete one or more of the incompatible software components or prompt the user to delete the software components.

The enterprise component specification knowledge base can identify dependencies or conflicts between existing software components that are displayed as well as any with selected software components. The identities of any existing software components that relate to or conflict with selected software components can be identified in the enterprise component specification knowledge base using software identifiers. Related software components can include any software component that an existing or selected software component depends on for successful operation. Conflicting software components can include software components that interfere with the operation of other software components. The enterprise component binary repository can contain libraries of enterprise component binaries and their respective version numbers. And the enterprise component template repository can contain information about software application types, such as Java and .Net, as well as information that controls a layer definition, such as which components belong to what layer.

The compatibility features can also include determining when one selected software component includes functionality that is reliant on the presence of another non-selected software component. Sometimes one selected software component is identified in the enterprise component specification knowledge base as being dependent on another non-selected software component. In that case, the PC 12 can automatically identify the non-selected software component using the software architecture tool and add it to the arrangement of selected software components on the display of the PC 12. Of the existing and selected software components, the enterprise component specification knowledge base can be used to identify when the software components conflict with each other and when additional software components should be added to the software components selected by the user. Furthermore, the display of the PC 12 can also visually distinguish between enterprise standard software and non-standard software, such as by color variations. For instance, each software component that is standard, such that it is found in the IT standard catalog, can be colored one color, (e.g., green) whereas software components that are non-standard can be colored a different color (e.g., blue). The method 200 proceeds to step 250.

At step 250 the software architecture tool can automatically place software components into appropriate tiers and layers. Optionally, a skeletal software application is built that includes software components from the existing software application and the selected software components using the repositories. The software architecture tool also creates an IT BOM and an incompatibility report. Once the needed software components for a skeletal software application have been determined to be present, the PC 12 can access the enterprise component binary repository that includes actual code used to implement the new software application. The new software application or skeletal software application can include updated documentation, such as a new IT BOM, a new build descriptor, and/or new physical java packaging sample code. The software components can be verified as they are arranged to identify any conflicts that may be present and if any conflict exists a conflict report will be generated. The skeletal software application can include binaries obtained from the enterprise component binary repository such that the skeleton can be built. In one implementation, the skeletal application can include existing physical Java packaging, sample code, unit tests, or build configuration artifacts for the software application. A number of software build tools can be used to carry this out, such as the integrated development environments (IDE) Eclipse, Rational Software Architect (RSA), Apache Ant, or Apache Maven. It is possible to include the software architecture tool as a software plug-in to the IDE. When the present method 200 is used, the IT BOM can be created along with the skeletal software application. The IT BOM can include a build list of the physical implementation of the software components included with the created skeletal software application. The build list of the IT BOM may also identify software components by a catalog number when they have been determined to be standard. Once the skeletal software application is created, it can be written to a non-volatile memory device that is communicatively linked to the PC 12, such as a flash drive inserted into a USB port or a portion of a non-volatile memory of the PC 12. The method 200 then ends.

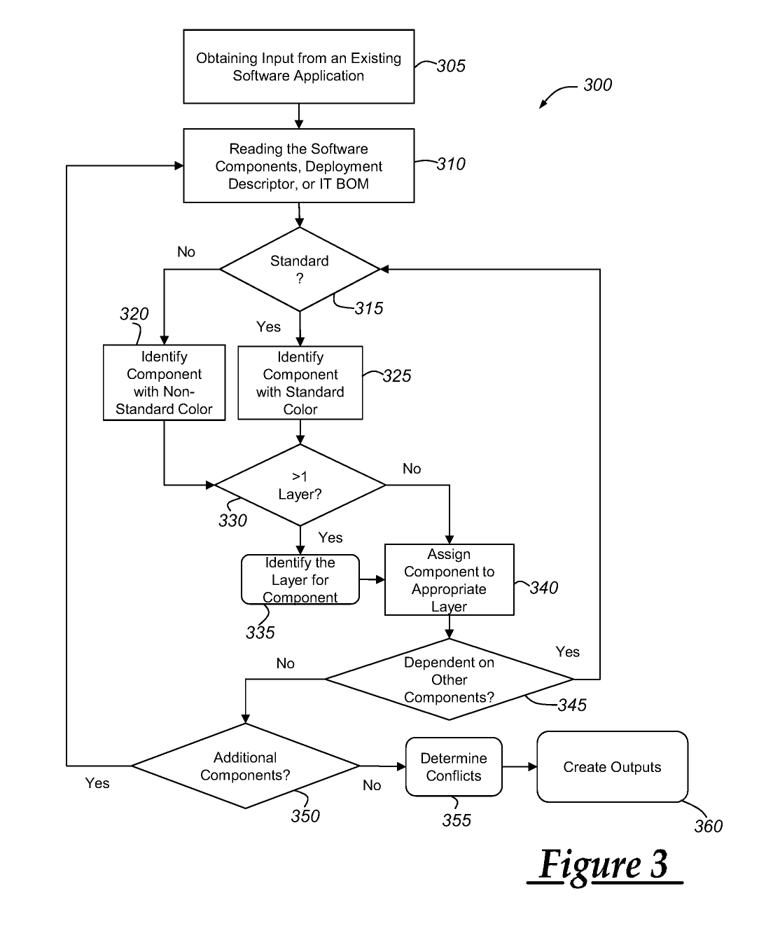

FIG. 3 depicts another embodiment of a method 300 of generating a new software application structure using a software architecture tool. The method 300 begins at step 305 by obtaining input from an existing software application in the form of software components, a deployment descriptor, or an IT BOM. The software architecture tool can access the existing software application from a non-volatile memory device that is communicatively linked with the software architecture tool. As discussed above, the PC 12 on which the software architecture tool is implemented can be communicatively linked to the memory device storing the existing software application. The method 300 proceeds to step 310.

At step 310, the software architecture tool can then read the software components, deployment descriptor, or IT BOM from the existing software application and begin determining which layer and tier each software component belongs with. The software components can then be displayed on a peripheral according to their location in a particular tier and layer. The method 300 proceeds to step 315.

At step 315, the software architecture tool can access the IT standard catalog and determine whether or not a software component from an existing software application is a standard software component or a non-standard component. If the software component is determined to be non-standard, the method 300 proceeds to step 320 and the software component can be identified on a peripheral of the PC 12 shown in FIG. 1 using a color that is common to non-standard software components. Otherwise, the method 300 proceeds to step 325 and the software component can be identified on a peripheral of the PC 12 of FIG. 1 using a color that is common to standard software components. The method 300 proceeds to step 330.

At step 330, the software architecture tool determines whether the software component belongs to more than one layer. If the software component belongs to more than one layer, the software architecture tool can prompt the user to identify which layer the software component from the existing software application belongs to. When the components only belong to one layer, the method proceeds to step 340 without user input. For standard components that could belong to more than one layer, the software architecture tool can prompt the user to identify which layer the software component should be placed. If the selected software component belongs to more than one layer, the user can identify the layer in which to place the software component at step 335. The software architecture tool can then assign the selected software component to the appropriate layer at step 340. The method 300 proceeds to step 345.

At step 345, the software architecture tool can determine whether or not the software component from the existing software application is dependent on other software components to function properly. To make this determination, the software architecture tool can access the enterprise component specification knowledge base and identify the selected component among stored software components and information associated with those stored software components. If the selected software component is determined to be dependent on other software components, the software architecture tool can select the dependent software component(s) and return to step 315. The dependent software components can then be processed as is described above beginning at step 315. If the selected software components are not determined to have dependent software components, the method 300 can proceed to step 350.

At step 350, the software architecture tool can determine whether or not additional software components should be obtained from the existing software application. If so, the method 300 returns to step 310 and the software architecture tool can receive a software component from the existing software application. Otherwise, the method 300 can proceed to step 355 and the software architecture tool can determine whether any conflicts exist among the existing software components. The method proceeds to step 360.

After identifying any conflicts, the software architecture tool can create a number of outputs at step 360. These outputs can include an incompatibility report identifying the conflicts between software components (if any) that can be based on a target operating system or a target application, a web server, or a container that are defined by a template in the enterprise component template repository. The outputs can also include an IT BOM, build descriptors, and a skeletal software application for a new software application as described above. The method 300 then ends.

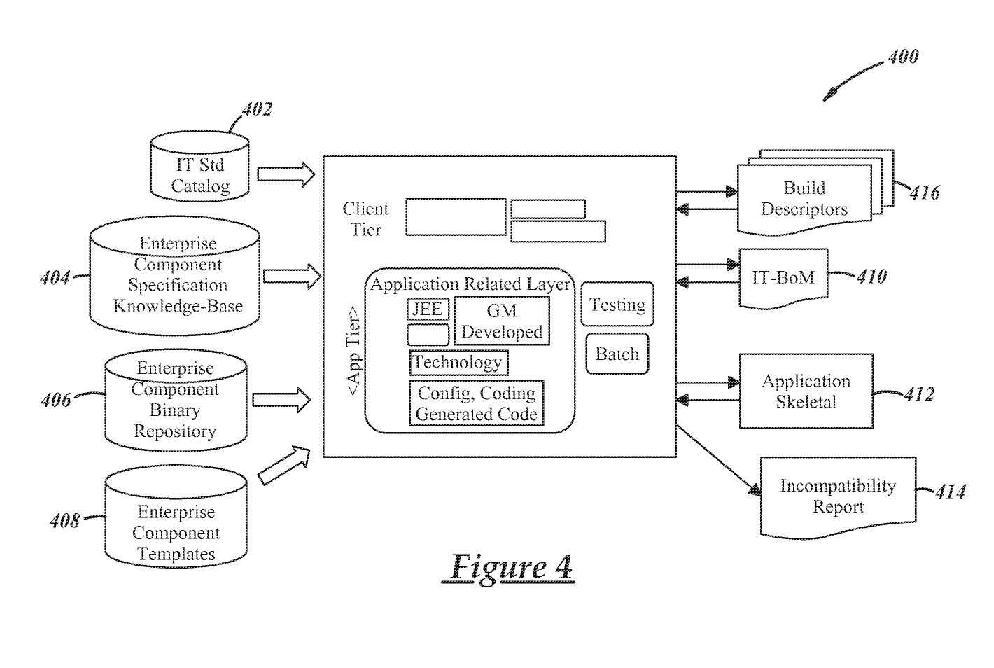

FIG. 4 depicts a flow diagram of the inputs and outputs of a software architecture tool 400. The software architecture tool 400 can receive inputs from any combination of the IT standard catalog 402, the enterprise component specification knowledge base 404, the enterprise component binary repository 406, or the enterprise component template repository 408. The software architecture tool 400 can also receive software components belonging to an existing software application or information relating to those software components from an IT BOM 410, a skeletal or existing application 412, or build descriptors 416. Using data from one or more of these repositories, the software architecture tool 400 can create an IT BOM 410, a new skeletal application 412, an incompatibility report 414, build descriptors 416, or any combination of these outputs for the new software application.

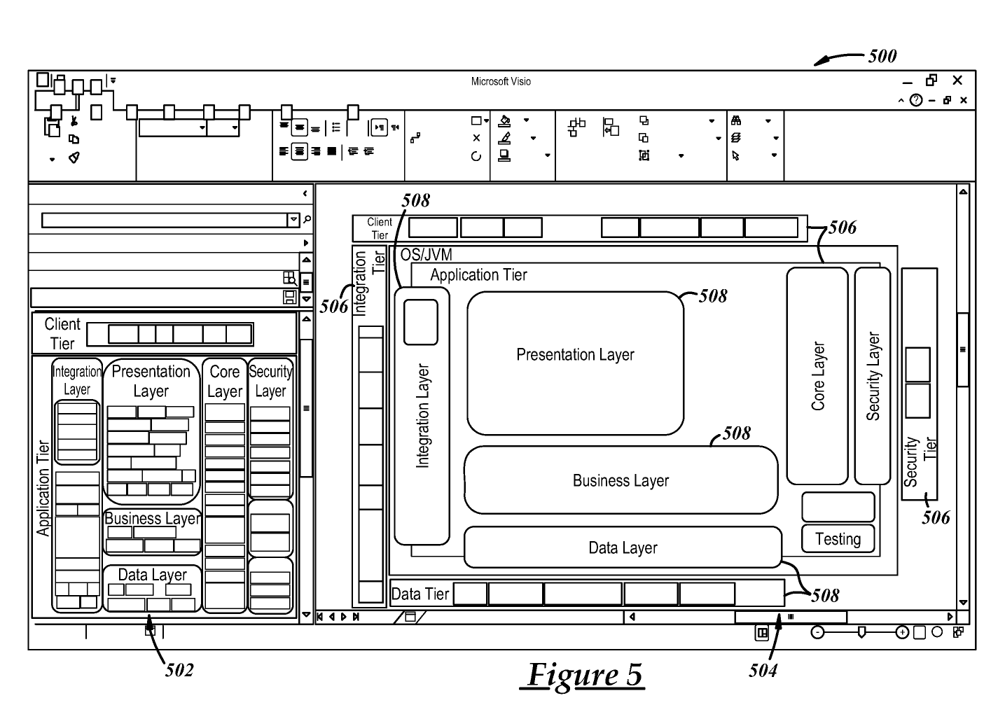

Turning to FIG. 5, there is shown an embodiment of a GUI for the software architecture tool. A screen shot of a GUI 500 as it would be displayed on a peripheral of the PC 12, such as a monitor, is shown in FIG. 5. A selection portion 502 of the GUI 500 can display software components offered to the user for architecting a software application. The user can select one or more software components from the selection portion 502 and drag those components into a building section 504 of the GUI. The building section 504 can organize the software components into a software tier 506 in which one or more software layers 508 can be included.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of displaying a software application using a software architecture tool, comprising the steps of:
(a) receiving a portion of an existing software application at the software architecture tool;
(b) identifying one or more software components of the existing software application from the received portion based on content accessed from an information technology (IT) standard catalog identifying software components that are recognized as being acceptable for use in vehicles;
(c) automatically identifying a tier and layer location for each standard software component of the existing software application; and
(d) presenting one or more images that each represent the standard software component to a user, wherein the images visually identify a tier and layer location of each standard software component.

2. The method of claim 1, further comprising the step of presenting one or more images that each represent an identified non-standard software component to a user, wherein the images visually identify a tier and layer location of each software component.

3. The method of claim 1, further comprising the step of presenting one or more images depicting a software component that belongs to more than one layer.

4. The method of claim 1, further comprising the step of receiving at the software architecture tool an IT bill of materials (IT BOM) that identifies one or more software components in the existing software application.

5. The method of claim 1, further comprising the step of receiving at the software architecture tool a deployment descriptor of the existing software application.

6. The method of claim 1, further comprising the step of identifying the tier and layer location of each software component by color.

7. The method of claim 1, further comprising the step of identifying the one or more software components as non-standard or standard according to color.

8. The method of claim 1, further comprising the step of generating a new skeletal software application that includes one or more identified software components and one or more user-selected software components.

9. The method of claim 8, further comprising the step of generating an information technology (IT) bill of materials (IT BOM) for the new skeletal software application.

10. The method of claim 8, further comprising the step of generating an incompatibility report for the new skeletal software application.

11. The method of claim 1, further comprising the step of displaying compatibility features between one or more software components of the existing software application and one or more user-selected software components according to color.

12. The method of claim 1, further comprising the step of receiving a software tier selection from the user for each identified software component of the existing software application.

13. The method of claim 1, further comprising the step of determining a software layer selection automatically for each identified software component of the existing software application.

14. The method of claim 1, further comprising the step of building a vehicular software application from the one or more software components of the existing software application.

15. The method of claim 14, further comprising the step of installing the vehicular software application on a vehicle.

16. A method of displaying a software application using a software architecture tool, comprising the steps of:
(a) receiving a portion of an existing software application at a software architecture tool;
(b) accessing an information technology (IT) standard catalog identifying software components as being acceptable for use in vehicles;
(c) identifying one or more software components of the existing software application from the received portion;
(d) determining whether software components are standard or non-standard and acceptable for use in vehicles;
(e) automatically identifying a tier and layer location for each standard software component;
(f) receiving one or more software selections from a user for non-standard components or when a software component belongs to a plurality of layers; and
(g) presenting one or more images to a user that each represent an identified software component, wherein the presented images identify a location within a tier and a layer.

17. The method of claim 16, further comprising the step of receiving at the software architecture tool a deployment descriptor of the existing software application.

18. The method of claim 16, further comprising the step of identifying the tier and layer of each software component or software selection by color.

19. The method of claim 16, further comprising the step of identifying the one or more software components or software selections as non-standard or standard according to color.

20. The method of claim 16, further comprising the step of building a vehicular software application from the one or more software components of the existing software application and one or more software components corresponding to the software selections.
